(19) United States
(12) Patent Application Publication
(10) Pub. No.: US 2025/0385276 A1
(43) Pub. Date: Dec. 18, 2025

(54) FUEL CELL STRUCTURE WITH REINFORCEMENT FOR ABSORBING LATERAL FORCES

(71) Applicant: Aerostack GmbH, Dettingen an der Erms (DE)

(72) Inventor: Manuel MORCOS, Dettingen an der Erms (DE)

(21) Appl. No.: 18/694,456

(22) PCT Filed: Sep. 23, 2022
(86) PCT No.: PCT/EP2022/076478

§ 371 Date: Feb. 28, 2025

(30) Foreign Application Priority Data
Sep. 24, 2021 (DE) 10 2021 124 791.8

(51) Int. Cl. H01M 8/0247; H01M 8/0276; H01M 8/2465

(52) U.S. Cl. CPC H01M 8/0247; H01M 8/0276; H01M 8/2465

(57) ABSTRACT

What is described is a fuel cell structure (100) having a first fuel cell (110a) and a second fuel cell (110b), which are stacked one on top of the other in a longitudinal direction (112) of the fuel cell structure (100). The first fuel cell (110a) and the second fuel cell (110b) contain a first plate (116), a second plate (118), an interlayer (120) and an elastic material (130). The interlayer (120) is arranged between the first plate (116) and the second plate (118). The elastic material (130) is arranged in the form of an electrical insulator in a peripheral region (140) of the fuel cell (110a, 110b) between the first plate (116) and the second plate (118). The first plate (116) and/or the second plate (118) contains a curved portion (150) in the peripheral region (140). The elastic material (130) bears against the curved portion (150), in order to conduct a lateral force acting in a transverse direction (114) of the fuel cell structure onto the curved portion (150).

### TECHNICAL FIELD

The present description relates in general to the technical field of fuel cell technology. In particular, the description relates to the structural design of a fuel cell structure, which can also be referred to as fuel cell stack.

### TECHNICAL BACKGROUND

Fuel cells are tried and tested sources of electrical energy. A single fuel cell usually supplies a voltage in the region of approximately 1 volt. In order to provide higher voltages, multiple fuel cells are electrically coupled to one another in a suitable way. It has been found to be expedient to also mechanically connect the mutually electrically coupled fuel cells. Such an assembly of multiple fuel cells is referred to as fuel cell stack or fuel cell structure.

A fuel cell structure can be used as a source of electrical power for various loads. Thus, a fuel cell structure can be used as an energy source in homes (generally at stationary points of need) or else in water, land or air vehicles (generally at mobile points of need). Depending on the field of use, various demands for mechanical stability or strength can be made on a fuel cell structure. In particular in the event of use at mobile points of need, it can be necessary for a fuel cell structure to have a given resistance against external influences or forces. This resistance can, for example, relate to the extent to which a fuel cell structure can absorb forces in the longitudinal or transverse direction and the extent to which the fuel cell structure can withstand vibrations or shocks.

### DESCRIPTION

An object can be considered that of improving the structural design of a fuel cell structure to the effect that the fuel cell structure can better withstand forces acting from the outside, in particular forces in the transverse direction of the fuel cell structure.

This object is achieved by the subject matter of the independent claims. Further embodiments will become apparent from the dependent claims and from the following description.

According to one aspect, a fuel cell structure is specified. The fuel cell structure comprises a first fuel cell and a second fuel cell. The first fuel cell and the second fuel cell are stacked one on top of the other in a longitudinal direction of the fuel cell structure. Both the first fuel cell and the second fuel cell comprise a first plate, a second plate, an interlayer and an elastic material. The interlayer is arranged between the first plate and the second plate. The elastic material is arranged in the form of an electrical insulator in a peripheral region of the fuel cell between the first plate and the second plate. The first plate and/or the second plate contains a curved portion in the peripheral region. The elastic material is configured such that it bears against the curved portion, with the result that the elastic material conducts an external lateral force acting in a transverse direction of the fuel cell structure onto the curved portion and the first plate and/or second plate conducts this lateral force onto the interlayer.

In a variant, the elastic material of a fuel cell is separated and at a spacing from an elastic material of a neighboring fuel cell. In another variant, the curved portion is additionally an angled portion, at which the first plate and/or the second plate is bent.

The advantage of this structure is that lateral forces are conducted into the interlayer. The interlayer is distinguished by high mechanical strength. As a result, the interlayer gives the fuel cell structure a high resistance to forces that act in the transverse direction, what are referred to as lateral forces. The lateral forces are conducted onto the curved portion via the elastic material. The lateral forces are introduced into the first and the second plate at this curved portion. The two plates absorb the forces and convey them in the direction of the interlayer.

In other words, the bipolar plates are curved in an peripheral region and an elastic material is arranged between the bipolar plates and conveys a force acting on the elastic material from the outside into the curved peripheral region of the bipolar plates. This effect is assisted in particular in that the elastic material extends to the outside beyond an outer periphery of the bipolar plates, in order to absorb the external force.

A bipolar plate curved in the peripheral region is shaped, for example, such that the bipolar plate has a U-shaped or hat-shaped cross section in this region, wherein the walls in the U-shaped cross section do not have to be perpendicular to one another, but can also extend at an angle to one another which differs from 90°. A longitudinal direction of the U-shaped cross section extends transversely to a normal force acting from the outside.

The curved peripheral region may, however, also comprise a shoulder or a step, wherein the step is configured such that the bipolar plate is stepped per se and over its entire material thickness in the peripheral region and does not simply have a depression in its surface.

The interlayer contains, for example, a support structure and an electrolyte. In this way, the interlayer performs a function in providing electrical energy, and absorbs mechanical loading along the longitudinal direction of the fuel cell structure. The mechanical loading along the longitudinal direction of the fuel cell structure is, for example, compressive forces that are exerted on the fuel cells stacked one on top of another by end plates of the fuel cell structure.

The elastic material is, for example, a seal or an electrical insulation layer, which is arranged between two electrodes of a fuel cell in order to prevent the two electrodes from being electrically connected to one another.

The design of a fuel cell structure described here is advantageously suitable in particular for such a fuel cell structure, in which the elastic material and the plates of a fuel cell are not fixedly connected to one another or do not have an integral configuration. That is to say, the plates of a fuel cell and the elastic material are separate elements. Since the first plate and/or the second plate have a curved portion in the peripheral region, a transmission of force or a force flow between the elastic material and the first plate and/or the second plate can still readily take place and the plates can convey this force flow into the center of the fuel cell structure.

The peripheral region of the fuel cell is defined, for example, as that region which is laterally (that is to say transversely to the longitudinal direction) further to the outside than the interlayer is. This means that the curved portion is further to the outside in the transverse direction of the fuel cell structure than the interlayer is.

The curved portion of the first plate and of the second plate is, for example, an offset portion, an angled portion, or a bead or depression made in the plates. The first plate and the second plate thus do not extend in a straight line along the transverse direction over their entire extent in the peripheral region. Instead, owing to the curved profile, the plates provide at least one portion which extends obliquely to the transverse direction, with the result that a transverse force (which contains at least one component acting in the transverse direction) acting on the elastic material is absorbed by the elastic material and can be conveyed into the fuel cell structure via the curved portion. If a transverse force acts on the elastic material, the elastic material is pressed in the direction of the curved portion and the plates absorb the transverse force at the curved portion and transmit it into the interior of the fuel cell structure.

The first plate and the second plate of the fuel cell may, for example, be made of a metallic material or contain a metallic material. Accordingly, the plates have comparatively good mechanical properties and a comparatively high strength compared to the elastic material. The plates can transmit a force acting from the outside into the core of the fuel cell structure. In order that such a force can also be readily transmitted from the elastic material to the plates, the plates contain the described curved portion in the peripheral region. The first plate and the second plate may, however, also be made of graphite or contain graphite, or be made of or contain a carbon composite material.

The longitudinal direction of the fuel cell structure is defined by virtue of how the individual fuel cells are stacked one on top of another. The direction in which the stack of the fuel cell structure grows when another fuel cell is placed on it corresponds to the longitudinal direction. If a fuel cell is considered to be approximately a planar element, the longitudinal direction typically extends orthogonally to a fuel cell.

The transverse direction of the fuel cell structure extends perpendicularly in relation to the longitudinal direction.

According to one embodiment, the elastic material projects beyond the first plate and the second plate in the transverse direction at least at some portions in the circumferential direction of the first plate and the second plate.

The elastic material can thus serve to absorb external forces or mechanical actions, with the result that these external mechanical actions are not applied directly to the plates of the fuel cell.

According to another embodiment, the elastic material projecting beyond the first plate and the second plate in the transverse direction extends obliquely in relation to the transverse direction.

The portions of the elastic material that project beyond the first and the second plate of the fuel cell are angled, for example, in the direction of the neighboring fuel cell. If a force acting from the outside in the transverse direction acts on these angled portions of the elastic material, this arrangement likewise ensures an advantageous distribution of the force acting from the outside.

According to another embodiment, the elastic material extends around the first plate and the second plate in the circumferential direction and at least partially surrounds the first plate and the second plate in the circumferential direction.

The elastic material does not necessarily have to extend along the entire circumference of the plates of the fuel cell. Rather, it can be sufficient if the elastic material extends only partially in the circumferential direction along the circumference of the fuel cell. Multiple elements that are separate from one another and are made of said elastic material may be arranged between the first plate and the second plate of a fuel cell. If the elastic material is introduced only in certain portions in the circumferential direction as individual, mutually spaced elements, this can for example reduce the overall weight of the fuel cell structure in comparison with an elastic material which extends uninterrupted around the entire circumference of a fuel cell.

According to another embodiment, the curved portion of the first plate and of the second plate contains a contact surface, wherein the contact surface extends obliquely to the transverse direction of the fuel cell structure.

The curved portion of the first plate and of the second plate is formed, for example, by a bend or an angled portion. The bend or the angled portion confers a higher mechanical strength on the plates of a fuel cell in the peripheral region. Furthermore, the curved portion formed by the bend or the angled part provides a contact surface, which provides an engagement surface, via which a force can be introduced from the elastic material onto the first plate and the second plate of the fuel cell. For example, the contact surface extends at an angle to the transverse direction of greater than 0° and less than 90°, in particular greater than 10° and less than 80°.

According to another embodiment, the curved portion of the first plate and of the second plate is a repeatedly bent portion.

A higher number of bends in the curved portion can contribute to providing the first plate and the second plate of a fuel cell with more stiffness or in general mechanical strength. In this configuration, too, the curved portion, irrespective of the number of bent portions, forms a contact surface to which the elastic material can transmit a force.

The bending edge of a bend can extend at least in certain portions along a circumferential direction of the fuel cell, that is to say transversely to the direction of action of a lateral force. It is, however, also conceivable that structure-reinforcing elements (material thickenings, reinforcements, further bending edges or folding edges) that extend along the transverse direction are additionally applied in the first plate and/or the second plate.

According to another embodiment, the elastic material forms an angled surface, which can be moved in the direction of the curved portion by a force acting in the transverse direction.

The angled surface of the elastic material may have, for example, an angle of inclination which is similar to or the same as that of the contact surface of the first plate and of the second plate of the fuel cell. If an external force also acts on the elastic material in the transverse direction, the elastic material yields and performs a movement in the transverse direction. In the process, the angled surface of the elastic material is moved in the direction of the contact surface of the first plate and of the second plate and exerts a force on the first plate and the second plate. The first plate and the second plate absorb the force acting in the transverse direction and transmit this force into the center of the fuel cell structure, where in particular the interlayer of the fuel cells absorbs this force.

According to another embodiment, the second plate of the first fuel cell and the first plate of the second fuel cell are connected to one another in the peripheral region via at least one mechanical connection.

This optional mechanical connection between two plates that lie next to one another or on one another of neighboring fuel cells can contribute to increasing the stiffness and mechanical strength of the plates in the peripheral region.

The mechanical connection may be, for example, an integrally bonded connection such as a welded connection (for example as a result of a spot welding operation), a soldered connection, or an adhesively bonded connection. The mechanical connection is preferably formed at certain points and has the function of connecting the neighboring plates of neighboring fuel cells to one another, in order to improve the conveyance of the transverse force via the corresponding plates. It is also possible, however, to use separate mechanical fastening means, such as rivets or bolts, for the mechanical connection.

According to another embodiment, the elastic material of the first fuel cell has an elevation on a surface facing toward the second fuel cell and the elastic material of the second fuel cell has a depression on a surface facing toward the first fuel cell, with the result that the elevation lies in the depression in a mounted state of the fuel cell structure.

The elastic material has both the function of electrically insulating the first plate and the second plate of a fuel cell from one another and the function of absorbing a force acting in the transverse direction of the fuel cell structure and introducing it into the first plate and the second plate.

The elevation on a surface of the elastic material and the depression on the facing surface of the neighboring elastic material form a form fit, with the result that a force acting on the elastic material of a fuel cell is also at least partially transmitted to the elastic material of the neighboring fuel cell. This can further improve the mechanical properties of the fuel cell structure in terms of its resistance to forces in the transverse direction.

According to another aspect, a fuel cell structure having a first fuel cell and a second fuel cell is specified, wherein the first fuel cell and the second fuel cell are stacked one on top of the other in a longitudinal direction of the fuel cell structure. Both the first fuel cell and the second fuel cell comprise a first plate, a second plate, an interlayer and an elastic material. The interlayer is arranged between the first plate and the second plate. The elastic material is arranged in the form of an electrical insulator in a peripheral region of the fuel cell between the first plate and the second plate. The fuel cell structure comprises a first force introduction element and a second force introduction element, wherein the first force introduction element is mounted on the first plate and on a second plate of a neighboring fuel cell in the peripheral region of the first fuel cell and wherein the second force introduction element is mounted on the second plate and on a first plate of another neighboring fuel cell in the peripheral region of the first fuel cell. The first force introduction element and the second force introduction element are configured to transmit a force acting in the transverse direction of the fuel cell structure to the plates of the fuel cells.

The force introduction elements are preferably made of electrically non-conductive material. The force introduction elements are made of or comprise, for example, a thermoplastic, a thermosetting plastic or an elastomer. The force introduction elements are arranged on two plates of neighboring fuel cells (for example by being molded on, cast on, adhesively bonded or using another mechanical connecting process) and serve to transmit a force acting in the transverse direction of the fuel cell structure to the plates, in order that the plates convey this force into the core of the fuel cell structure, where the force can be absorbed by suitable elements, such as the interlayer.

For this configuration of the fuel cell structure, the same statements and features as are described for the fuel cell structure in other embodiments apply in terms of the structure of the plates of the fuel cells. Thus, for example, the plates may have a curved portion with a contact surface. However, the plates may also extend in a straight line in the transverse direction if the plates are suitable for absorbing the expected forces in the transverse direction, for example owing to their nature in terms of the material used and the geometry and dimensions of the plates. For this, the plates may be made of a suitable material. It is conceivable that the plates contain suitable reinforcing structures, which increase the mechanical strength of the plates.

In this variant of the fuel cell structure, the force introduction elements serve to absorb a lateral force acting from the outside and introduce it into the plates of the fuel cells. The plates then convey the force to the core of the fuel cell structure. In the variant of the fuel cell structure described above, this task is undertaken by the elastic material. As regards the conveying of an external lateral force to the plates of the fuel cells, the elastic material and the force introduction elements perform mutually corresponding functions.

### BRIEF DESCRIPTION OF THE FIGURES

Exemplary embodiments are discussed in more detail below with reference to the appended drawings. The illustrations are schematic and not true to scale. The same reference signs denote identical or similar elements. In the figures:

FIG. 1 shows a schematic illustration of a fuel cell structure.

FIG. 2 shows a schematic illustration of a fuel cell with elements of neighboring fuel cells in a fuel cell structure.

FIG. 3 shows a schematic cross-sectional illustration of the peripheral region of a fuel cell.

FIG. 4 shows a schematic illustration of the plan view of a fuel cell.

FIG. 5 shows a schematic cross-sectional illustration of the peripheral region of a fuel cell.

FIG. 6 shows a schematic cross-sectional illustration of the peripheral region of a fuel cell.

FIG. 7 shows a schematic cross-sectional illustration of the peripheral region of a fuel cell.

FIG. 8 shows a schematic cross-sectional illustration of the peripheral region of a fuel cell.

FIG. 9 shows a schematic cross-sectional illustration of the peripheral region of a fuel cell.

FIG. 10 shows a schematic cross-sectional illustration of the peripheral region of a fuel cell.

### DETAILED DESCRIPTION OF EXEMPLARY EMBODIMENTS

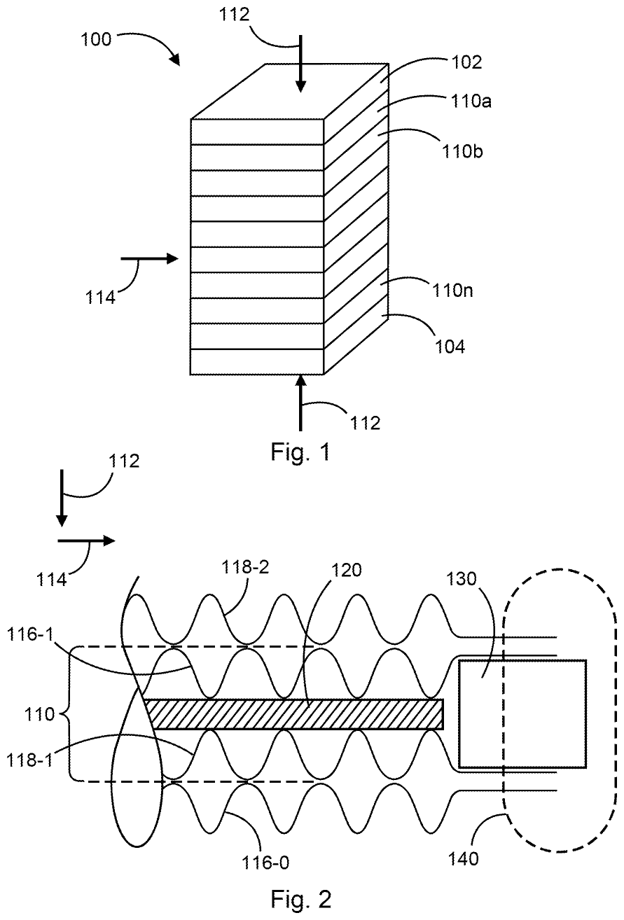

FIG. 1 shows a fuel cell structure 100, which can also be referred to as fuel cell stack. The fuel cell structure 100 comprises a first end plate 102 and a second end plate 104. Multiple fuel cells 110a, 110b, . . . , 110n are arranged between the first end plate 102 and the second end plate 104. The fuel cells are stacked one on top of another in the longitudinal direction 112 of the fuel cell structure 100. In one fuel cell structure 100, for example, 300 to 500 individual fuel cells can be stacked one on top of another, in order to provide the required energy, in particular the required output voltage. Owing to the number of fuel cells, the fuel cell structure 100 can have a significant extent in the longitudinal direction 112. Accordingly, forces acting in the transverse direction 114 can affect the stability of the fuel cell structure.

FIG. 2 schematically shows the structure of a fuel cell 110 from the stack of the fuel cell structure 100 in FIG. 1. The fuel cell 110 comprises a first plate 116-1, a second plate 118-1, an interlayer 120 and an elastic material 130. The first plate 116-1 and the second plate 118-1 constitute the electrodes of the fuel cell 110. These electrodes may be, for example, bipolar plates, the surfaces of which have channels through which a gas as fuel for the fuel cell can flow. The plates of the fuel cell serve as tap for the electrical potential of a fuel cell. By electrically connecting more fuel cells, a correspondingly greater voltage can be provided.

The interlayer 120 is arranged between the first plate 116-1 and the second plate 118-1 of the fuel cell 110. The interlayer consists of a support structure and an electrolyte (neither is shown separately). The support structure serves to absorb the force of the weight of the neighboring fuel cells and the clamping force exerted by the end plates 102, 104. The function of an electrolyte in a fuel cell is known, and therefore will not be discussed separately at this juncture. The interlayer 120 may contain all known and any type of support structures and electrolyte.

Adjoining the first plate 116-1 of the fuel cell 110 is a second plate 118-2 of a neighboring fuel cell (located above the fuel cell in the longitudinal direction 112), which is not depicted in its entirety. Adjoining the second plate 118-1 of the fuel cell 110 is a first plate 116-0 of a neighboring fuel cell (located below the fuel cell in the longitudinal direction 112), which is not depicted in its entirety.

A fuel cell 110 contains a peripheral region 140, which, in the transverse direction 114, is located outside the region in which the interlayer 120 extends. An elastic material 130 is arranged between the first plate 116 and the second plate 118 of the fuel cell 110 in this peripheral region 140. The elastic material has, among other things, the function of electrically insulating the first plate 116 and the second plate 118 from one another in the peripheral region 140.

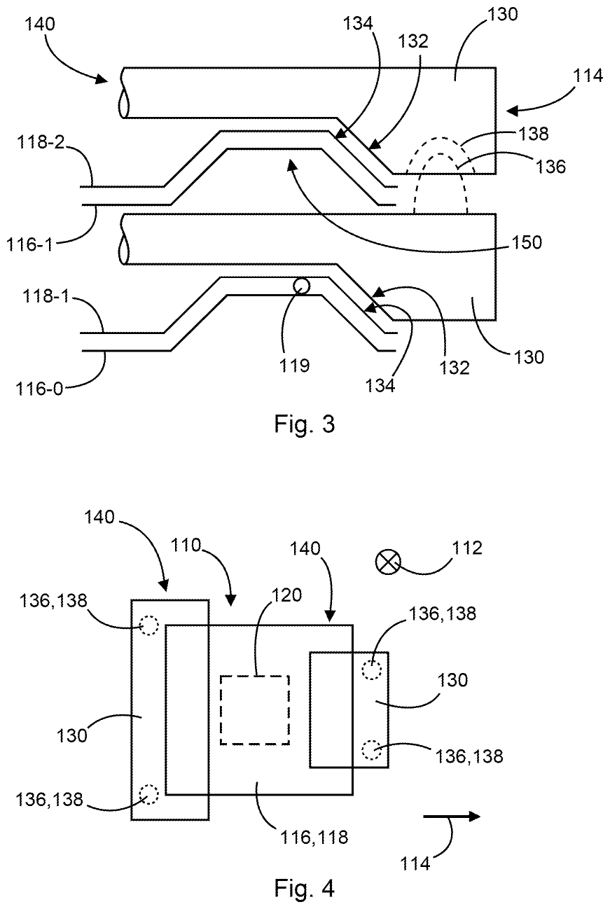

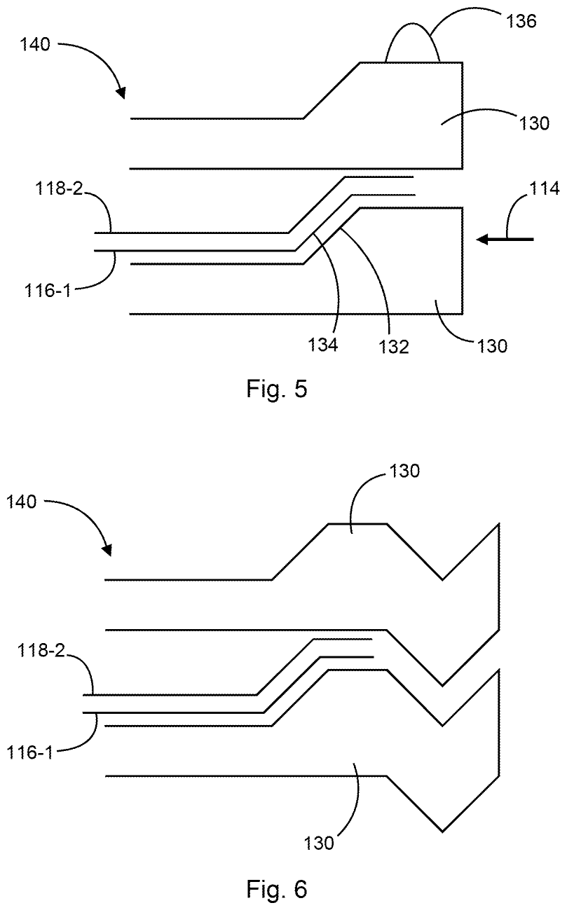

FIG. 3 shows a detailed illustration of the configuration of the fuel cell in the peripheral region 140. FIG. 3 shows in particular the plates of neighboring fuel cells and the elastic material 130. FIG. 3 denotes the plates of the neighboring fuel cells with the same reference signs 116-0, 118-1, 116-1, 118-2 as were already used in FIG. 2, in order that the plates can be assigned to the respective neighboring fuel cells in the illustration of only the peripheral region 140, too. This also applies to the illustrations in FIG. 5 to FIG. 10.

Two plates 116-1 and 118-2 of neighboring fuel cells have the same or a similar shape. These plates form a curved portion 150. The curved portion may be at least one angled part, bend, offset, depression or bead or contain such a structure-shaping element. The curved portion forms a contact surface 134. The curved portion 150 can in this example also be referred to as hat profile.

The elastic material 130 forms an angled surface 132. The angled surface 132 and the contact surface 134 face one another. In an unloaded state, the angled surface 132 may be at a spacing from the contact surface 134, for example by several tenths or hundredths of a millimeter or more. If a lateral force acts on the elastic material 130 from the outside in the transverse direction 114, the elastic material 130 is deformed and presses the angled surface 132 onto the contact surface 134.

As a result, the lateral force is transferred from the elastic material 130 to the plates 116-1, 118-2 (and analogously from the elastic material of the neighboring fuel cell to the plates 116-0, 118-1). The plates 116-1, 118-2 convey the force in the transverse direction 114 into the core of the fuel cell or of the fuel cell structure. There, the plates 116-1, 118-2 transfer the lateral force, for example into the support structure of the interlayer 120. This increases the resistance of a fuel cell structure 100 having a multiplicity of fuel cells 110 with respect to forces acting in the transverse direction 114 of the fuel cell structure 100.

Optionally, the elastic materials 130 of neighboring fuel cells may be formed with an elevation 136 on a first surface and a depression 138 on a facing second surface. When the fuel cells 110 are stacked, the elevation 136 of the elastic material 130 of a first fuel cell engages in the depression of the elastic material 130 of a neighboring second fuel cell. Therefore, forces acting on the elastic material of a fuel cell can also be transmitted to a neighboring fuel cell and thus better distributed in the fuel cell structure 100.

As an alternative to the configuration shown in FIG. 3 with an elevation 136 and a corresponding depression 138 on the elastic material 130 of the neighboring fuel cell, the elastic material 130 can also be formed without the depression 138. In this case, the elastic material 130 has one or more rib-like elevations on a surface (at the top or bottom), while the elastic material of the neighboring fuel cell does not have a depression on the surface which makes contact with the elevations. When the fuel cells are stacked one on top of another in this configuration, the surface with the elevations is pressed against the flat surface of the elastic material of the neighboring fuel cell, as a result of which a clamping force is generated in the longitudinal direction of the fuel cell structure, which can additionally contribute to the stability of the fuel cell structure. This variant corresponds to the variant without a recess 138 illustrated in FIG. 3, wherein the elevation 136 is pressed against a flat point on the lower surface of the neighboring elastic material.

The mutually adjoining plates of neighboring fuel cells may be connected to one another by means of a mechanical connection 119, with the result that a relative displacement of these mutually adjoining plates in the transverse direction 114 is avoided. The mechanical connection 119 can also contribute to increasing the mechanical stability of the two plates in the peripheral region, with the result that a force acting in the transverse direction 114 is introduced more readily into the interlayer 120.

FIG. 4 shows a plan view of a fuel cell 110 with the plates 116, 118. This illustration shows that the elastic material 130 does not have to extend over the entire circumference of the fuel cell 110. Instead, the elastic material 130 may be arranged on individual and mutually separate, spaced-apart portions. In FIG. 4, an elastic material is arranged on the left-hand side and a further elastic material is arranged on the right-hand side of the fuel cell 110. The interlayer 120 is arranged in the middle of the fuel cell 110. The elastic material 130 is arranged in the peripheral regions 140 of the fuel cell 110. Usually, the elastic material 130 is at a spacing from the interlayer 120 in the transverse direction 114. It is conceivable that the elastic material 130 adjoins the interlayer 120.

The elastic materials 130 are also shown in FIG. 4 such that they contain a depression 138 and a corresponding elevation 136, as already described in relation to FIG. 3. In order to be able to contextualize the perspective of FIG. 4, the directions 112, 114 are depicted. The longitudinal direction 112 extends into the plane of the drawing and the transverse direction 114 extends from left to right.

FIG. 5 shows a detailed illustration of the peripheral region 140. Similarly to the illustration in FIG. 3, FIG. 5 shows only the decisive elements, specifically the plates 116-1, 118-2 of neighboring fuel cells and the elastic materials 130.

By contrast to FIG. 3, in the example in FIG. 5 the plates 116-1, 118-2 are formed with a few bending edges. The plates 116-1, 118-2 are offset in the example in FIG. 5. The action achieved here, however, is the same as in the case of the hat profile in FIG. 3. A force acting in the transverse direction 114 deforms the elastic material 130 and this force is transmitted to the contact surface 134 of the two plates via the angled surface 132 of the elastic material 130, with the result that the plates transmit the force into the core of the fuel cell structure 100.

As already described in connection with FIG. 3, the elastic material 130 may have an elevation 136, which is shown here on the upper surface of one elastic material 130. The elevation 136 and an associated depression 138 (not shown; see FIG. 3) are preferably arranged on all the elastic materials 130 of neighboring fuel cells 110.

FIG. 6 shows a modification to the illustration from FIG. 5. At this juncture, only the differences will be discussed. The elastic materials 130 have pyramidal or triangular bulges at their outer periphery, which engage in a corresponding depression in the elastic material 130 of the neighboring fuel cell. FIG. 6 shows a cross section. It should be noted that the bulge can extend on the elastic material along the circumferential direction of the fuel cell. By contrast to a form-fitting connection at certain points between the elastic materials of neighboring fuel cells, such a design with a bulge and an associated depression, which extends along the elastic material, results in a transmission of force between neighboring elastic materials over a longer portion. For details regarding the transmission of force between the elastic material 130 and the plates 116-1, 118-2, reference is also made to the description of FIG. 3 and FIG. 5.

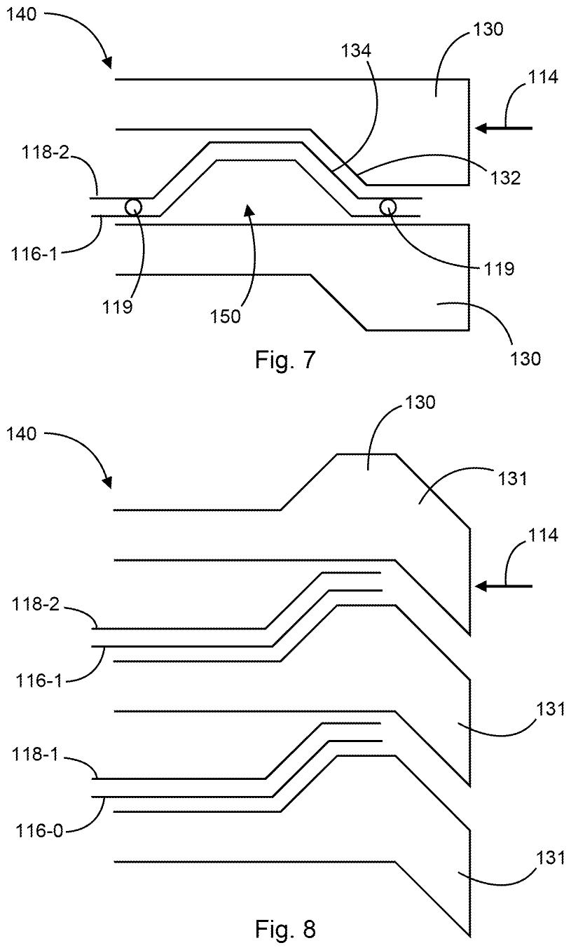

FIG. 7 shows a cross-sectional illustration of the peripheral region 140. The illustration of FIG. 7 is very similar to the illustration in FIG. 3 and differs only in that two mechanical connections 119 are arranged between the plates 116-1 and 118-2. The two mechanical connections 119 are arranged such that the curved portion 150 is arranged between the two mechanical connections 119. An advantage of this can be that the strength of the plates and the curved portion is increased in that a respective mechanical connection 119 is arranged at each end of the curved portion or on each side of the curved portion. For the rest of the features, reference is also made to the description of FIG. 3.

FIG. 8 shows a cross-sectional illustration of the peripheral region 140. The design of the peripheral region 140 in FIG. 8 is similar to the design in FIG. 5 and differs in that an end portion 131 of the elastic material 130 extends obliquely in relation to the transverse direction 114. If a force is exerted on the end portions 131 from right to left in the example in FIG. 8, the end portions 131 of neighboring fuel cells deform initially in the direction of the neighboring fuel cell. As a result, the force exerted is exerted on the elastic materials of at least two neighboring fuel cells, with the result that this exerted force is distributed among multiple neighboring fuel cells, even if the force is exerted at certain points. The further force flow through the elastic material 130 and the plates of the fuel cells corresponds to that described in relation to the preceding figures.

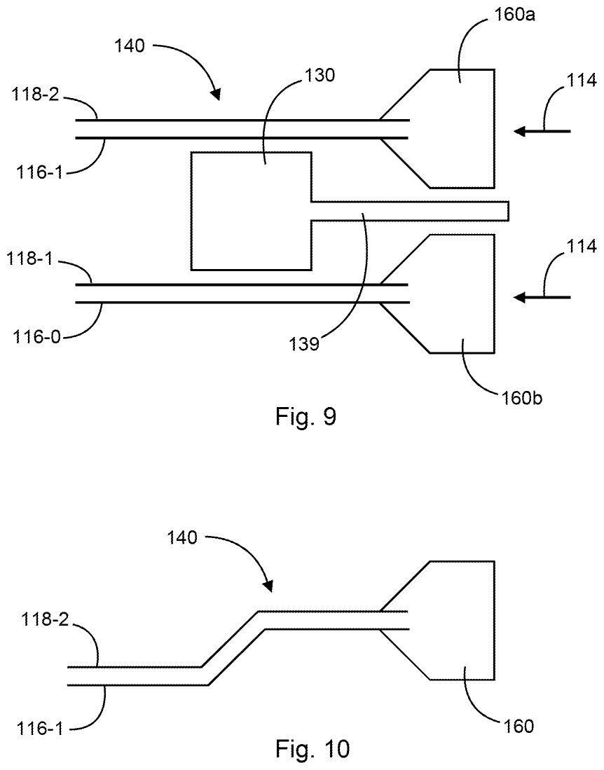

FIG. 9 shows a variant of the peripheral region 140 with a structurally slightly different design than what is shown in FIG. 3 to FIG. 8. In FIG. 9, a first force introduction element 160a is arranged on the two plates 116-1, 118-2 of neighboring fuel cells. A second force introduction element 160b is arranged on the two plates 116-0, 118-1. The force introduction elements serve to absorb an external force in the transverse direction 114 and introduce it into the plates 116-0, 118-1, 116-1, 118-2, which conduct the force further in the direction of the center of the fuel cell structure 100, in particular into the support structure of the interlayer 120.

An elastic element 130 is arranged between the plates 116-1 and 118-1. The primary function of the elastic element 130 here is to electrically insulate the plates of an individual fuel cell with respect to one another. The force is introduced not via the elastic element 130 but via the force introduction elements 160a, 160b, which are fixedly connected to two respective neighboring plates. The plates of the fuel cells are illustrated as planar (that is to say, without a curved portion) in FIG. 9. The plates may, however, also have a curved portion, as shown in FIG. 10.

It should additionally be pointed out that “comprising” or “having” does not rule out other elements or steps, and “a”, “an” or “one” does not rule out a multiplicity. It is furthermore pointed out that features or steps that have been described with reference to one of the above exemplary embodiments may also be used in combination with other features or steps of other exemplary embodiments described above. Reference signs in the claims should not be interpreted as restricting.

### LIST OF REFERENCE SIGNS

100 Fuel cell structure
102 First end plate
104 Second end plate
110 Fuel cell
112 Longitudinal direction
114 Transverse direction
116 First plate
118 Second plate
119 Mechanical connection
120 Interlayer
130 Elastic material
131 End portion, extends obliquely to the transverse direction
132 Angled surface
134 Contact surface
136 Elevation
138 Depression
139 Tongue
140 Peripheral region
150 Curved portion
160 Force introduction element

1. Fuel cell structure (100), comprising:
a first fuel cell (110a) and a second fuel cell (110b);
wherein the first fuel cell (110a) and the second fuel cell (110b) are stacked one on top of the other in a longitudinal direction (112) of the fuel cell structure (100);
wherein both the first fuel cell (110a) and the second fuel cell (110b) comprise:
a first plate (116);
a second plate (118);
an interlayer (120), which is arranged between the first plate (116) and the second plate (118);
an elastic material (130), which is arranged in the form of an electrical insulator in a peripheral region (140) of the fuel cell (110a, 110b) between the first plate (116) and the second plate (118);
wherein the first plate (116) and/or the second plate (118) contains a curved portion (150) in the peripheral region (140);
wherein the elastic material (130) is configured such that it bears against the curved portion (150), with the result that the elastic material (130) conducts an external lateral force acting in a transverse direction (114) of the fuel cell structure onto the curved portion (150) and the first plate (116) and/or second plate (118) conducts this lateral force onto the interlayer (120).

2. Fuel cell structure (100) according to claim 1, wherein the elastic material (130) projects beyond the first plate (116) and the second plate (118) in the transverse direction (114) at least at some portions in the circumferential direction of the first plate (116) and the second plate (118).

3. Fuel cell structure (100) according to claim 2, wherein the elastic material (130) projecting beyond the first plate (116) and the second plate (118) in the transverse direction (114) extends obliquely in relation to the transverse direction (114).

4. Fuel cell structure (100) according to one of the preceding claims,
wherein the elastic material (130) extends around the first plate (116) and the second plate (118) in the circumferential direction and at least partially surrounds the first plate (116) and the second plate (118) in the circumferential direction.

5. Fuel cell structure (100) according to one of the preceding claims,
wherein the curved portion (150) of the first plate (116) and of the second plate (118) contains a contact surface (134);
wherein the contact surface (134) extends obliquely to the transverse direction (114) of the fuel cell structure.

6. Fuel cell structure (100) according to one of the preceding claims,
wherein the curved portion (150) of the first plate (116) and of the second plate (118) is a repeatedly bent portion.

7. Fuel cell structure (100) according to one of the preceding claims,
wherein the elastic material (130) forms an angled surface (132), which can be moved in the direction of the curved portion (150) by a force acting in the transverse direction (114).

8. Fuel cell structure (100) according to one of the preceding claims,
wherein the second plate (118) of the first fuel cell (110a) and the first plate (116) of the second fuel cell (110b) are connected to one another in the peripheral region (140) via at least one mechanical connection (119).

9. Fuel cell structure (100) according to one of the preceding claims,
wherein the elastic material (130) of the first fuel cell (110a) has an elevation (136) on a surface facing toward the second fuel cell (110b), and wherein the elastic material (130) of the second fuel cell (110b) has a depression (138) on a surface facing toward the first fuel cell (110a), with the result that the elevation (136) lies in the depression (138) in a mounted state of the fuel cell structure (100).

10. Fuel cell structure (100), comprising:
a first fuel cell (110a) and a second fuel cell (110b);
wherein the first fuel cell (110a) and the second fuel cell (110b) are stacked one on top of the other in a longitudinal direction (112) of the fuel cell structure (100);
wherein both the first fuel cell (110a) and the second fuel cell (110b) comprise:
a first plate (116);
a second plate (118);
an interlayer (120), which is arranged between the first plate (116) and the second plate (118);
an elastic material (130), which is arranged in the form of an electrical insulator in a peripheral region (140) of the fuel cell (110a, 110b) between the first plate (116) and the second plate (118);
wherein the fuel cell structure (100) comprises a first force introduction element (160a) and a second force introduction element (160b);
wherein the first force introduction element (160a) is mounted on the first plate (116-1) and on a second plate (118-2) of a neighboring fuel cell in the peripheral region (140) of the first fuel cell (100a);
wherein the second force introduction element (160b) is mounted on the second plate (118-1) and on a first plate (116-0) of another neighboring fuel cell in the peripheral region (140) of the first fuel cell (100a);
wherein the first force introduction element (160a) and the second force introduction element (160b) are configured to transmit a force acting in the transverse direction (114) of the fuel cell structure (100) to the plates of the fuel cells.
